(19) United States
(12) Patent Application Publication
(10) Pub. No.: US 2019/0194518 A1
(43) Pub. Date: Jun. 27, 2019

(54) THERMAL INTERFACE MATERIAL

(71) Applicant: 3M INNOVATIVE PROPERTIES COMPANY, St. Paul, MN (US)

(72) Inventors: Melvina Leolukman, Bandung (ID); Appuswamy Devasenapathi, Singapore (SG); Arokiaraj Jesudoss, Bengaluru (IN); HongQian Bao, Singapore (SG)

(21) Appl. No.: 16/330,265

(22) PCT Filed: Sep. 8, 2017
(86) PCT No.: PCT/US2017/050602

§ 371 Date: Mar. 4, 2019

(30) Foreign Application Priority Data
Sep. 9, 2016 (SG) 10201607550R

(51) Int. Cl. C09K 5/14; C09D 183/08; C09D 7/61; C08K 3/04; C08K 3/28; C08K 3/38

(52) U.S. Cl. CPC C09K 5/14; C09D 183/08; C09D 7/61; C08K 2201/001; C08K 3/28; C08K 3/38; C08K 2003/385; C08K 3/04

(57) ABSTRACT

The present invention relates to a composite material for use as a thermal interface material between a heat source and a heat sink. The present invention also relates to the method of synthesizing such a composite material. The composite material has high thermal conductivity, low thermal resistance and functions as an adhesive.

### CROSS REFERENCE TO RELATED APPLICATION

This application claims priority to Singapore Patent Application No. 10201607550R, filed on Sep. 9, 2016, the disclosure of which is incorporated by reference in its entirety.

### TECHNICAL FIELD

The present invention relates to a surface modified nitride coated on a thermally conductive component as a thermal interface material and a method for making the same.

### BACKGROUND ART

The operation of miniature electronic devices generates heat, and the amount of heat that is generated has increased over the years due to increased power consumption in response to increasingly complex computation and electronic processes. To minimize the adverse effects of the increased generation of heat on the performance of electronic devices, heat transfer paths to dissipate heat are required. A common method for heat dissipation is to use heat sinks made of materials such as metals (e.g. aluminium, copper and silver), diamond and composite materials with high thermal conductivity. FIG. 1 shows a prior art examples of heat sinks used to dissipate heat from a heat generating device.

In order to achieve effective heat dissipation, low thermal resistance of the interface between the heat sink and the heat source is crucial. The effectiveness of heat dissipation depends on: (i) the degree of smoothness of the adjoining surfaces of the device and of the heat sink and (ii) the geometric cross-sectional area of the conductive path. However, as the surfaces of the heat sink and heat sources are usually not perfect, these irregularities, even on the microscopic scale, form pockets and gaps in which air can be entrapped. These air gaps reduce the heat transfer efficiency as a result of reduction in effective contact area and the low thermal conductivity of air (0.027 W/m° C.). To alleviate these problems, a thermal interface material (TIM) is used between the heat sink and the heat source to fill the surface irregularities and eliminate air pockets and gaps. Such a TIM is also shown in FIG. 1, placed between the heat generating device and the heat sink. Due to the small size of current electronic components and the relatively low thermal conductivity of the thermal interface materials, a thermal interface material needs to be applied in the form of a film. Desired properties of a thermal interface material include high thermal conductivity, high fluidity (consequently high conformability to the surfaces of heat sink and heat source) and good thermal stability.

Essentially, there are five kinds of thermal interfaces which are used in power electronics applications. These include: (i) thermal greases which are thermally conductive ceramic fillers dispersed in silicone or hydrocarbon oils to form a paste, (ii) gels of aluminum, silver, silicon, or olefin compounds that are converted to a cured rubber film after application at the thermal interface, (iii) elastomer films which are silicone elastomer pastes filled with thermally conductive ceramic particles reinforced with woven glass fiber or dielectric film, (iv) thermal conductive adhesive tapes which are double-sided pressure sensitive adhesive films that are filled with ceramic powder and supported with either aluminum foil or polyimide film, and (v) phase change materials which are a thixotropic, paste-like product which when heated to the crossover temperature, turns to liquid and fills the voids before returning to a solid.

However, some of the drawbacks of conventional thermal interface materials are low thermal conductivity, the fact that large gaps may not be able to be filled, lack of reusability, inability to apply to large areas, and high cost in production.

There is therefore a need to provide a composite material that overcomes or at least ameliorates, one or more of the disadvantages described above.

### SUMMARY

In a first aspect, there is provided a composite material comprising a thermally conductive component coated with a surface modified nitride, wherein the nitride is surface modified with at least one silane compound having the following formula (I):

R¹—(X¹)ₙ—(CR³R⁴)ₘ—SI(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl;

each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.

Advantageously, the surface modified nitride may have the dual function of heat conduction through the well-connected nitride particles such as boron nitride (BN) particles, as well as adhering the thermally conductive component to a heat source and/or a heat sink. In the present study, the thermally conductive component is coated with surface modified nitride which can advantageously completely replace conventionally used adhesives while decreasing thermal resistance at the interface. The use of surface modified nitride and therefore circumventing the use of conventional adhesives may have the advantages of (i) complete electrical insulation at the interface and (ii) low dielectric constant.

Conventional thermally conductive adhesive transfer tapes may have a thermal conductivity in the range of 0.5-0.9 W/mK and thermal impedance of about 0.32-1.5 ° C.-in²/W (2.1-9.7 ° C.-cm²/W). In contrast, the composite material of the present disclosure may have a thermal conductivity in the range of 1.38-1.59 W/mK which is advantageously much higher than conventionally available products and further has lower thermal resistance at the interface. Further, the composite material of the present disclosure may advantageously have a thermal resistance which is much lower than that of conventionally available products.

In another aspect, there is provided a method for synthesizing a composite material as defined above, comprising the steps of:

contacting a nitride and at least one compound having the following formula (I):

R¹—(X¹)ₙ—(CR³R⁴)ₘ—Si(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl;

each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.

Advantageously, the method enables fast and efficient surface modification of the nitride.

In another aspect, there is provided a material obtainable by the method as defined above.

In another aspect, there is provided an article comprising a composite material as defined above, bonded onto a heat source, a heat sink or both.

Advantageously, the surface modified nitride may be used on one side or on two sides of the thermally conductive component in the form of a sheet, to bond with a heat source and/or a heat sink with improved heat dissipation.

Advantageously, even if the surface modified nitride is coated on both sides of the thermally conductive component, the total thermal resistance may still be lower compared to conventional thermal interface materials.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram showing how a thermal interface material (TIM) of the prior art works between a heat generating device and a heat spreading and/or sinking device.

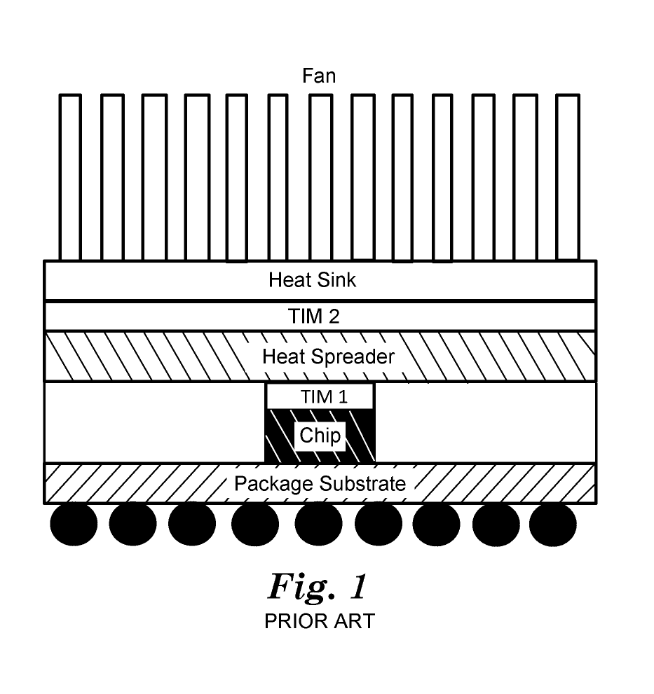

FIG. 2 is a schematic diagram comparing the composite material of the present disclosure (FIG. 2B) to that of conventional products (FIG. 2A).

FIG. 3 shows the FTIR spectra of the as obtained h-BN, 3-glycidoxypropyltrimethoxysilane (GPTMS) and the h-BN that has been surface modified with GPTMS (ES3 with h-BN:GPTMS ratio of 1:1.5).

FIG. 4 shows the FTIR spectra of the as obtained h-BN, 3-glycidoxypropyltrimethoxysilane (GPTMS), 3-mercaptopropyl trimethoxysilane (MPTMS), and the h-BN that has been surface modified with a mixture of GPTMS and MPTMS (h-BN: GPTMS-MPTMS ratio of 1:1.5).

FIG. 5 refers to graphs showing the thermal conductivity of h-BN layers surface modified with: (FIG. 5A) 3-glycidoxypropyltrimethoxysilane (GPTMS, ES3 with h-BN:GPTMS ratio of 1:1.5) and (FIG. 5B) mixture of 3-glycidoxypropyltrimethoxysilane (GPTMS) and 3-mercaptopropyltrimethoxysilane (MPTMS) (ES-MS3 with BN to silane ratio of 1:1.5).

FIG. 6 refers to a graph showing the total thermal resistance of the LED package as measured using T3STer equipment.

FIG. 7 refers to a graph showing the total thermal resistance of the LED package as measured using T3STer equipment.

FIG. 8 refers to a graph showing a comparison between the total thermal resistance of the LED package as measured using T3STer equipment.

FIG. 9 refers to scanning electron microscope (SEM) images showing the (FIG. 9A) cross section of the surface modified h-BN on graphite film bonded with aluminium substrate (scale bar represents 100 μm) and (FIG. 9B) graphite film, h-BN layer and the interface without air gaps or hairlines due to better bonding (scale bar represents 1 μm).

### DETAILED DESCRIPTION

### Definitions

The following words and terms used herein shall have the meaning indicated:

The term “heat source” refers to any electronic or mechanical device that generates heat.

The term “heat sink” refers to a passive heat exchanger that transfers the heat generated by an electronic or a mechanical device. For the purposes of this disclosure, the heat sink is made of a material that has high thermal conductivity, such as metals (e.g. aluminium, copper and silver), diamond and composite materials that have high thermal conductivity. The transferred heat leaves the device with the fluid in motion, therefore allowing the regulation of the device temperature at physically feasible levels.

The term “BN” may be used interchangeably with the term “boron nitride”, and refers to a chemical compound having the formula BN.

The term “h-BN” may be used interchangeably with the term “hexagonal boron nitride”, “hexagonal BN”, “α-BN”, or “g-BN (graphitic BN)” and refers to a crystalline form of boron nitride having a point group of D₆ₕ and space group of P6₃/mmc. h-BN has a layered structure similar to graphite. Within each layer, boron and nitrogen atoms are bound by strong covalent bonds, whereas the layers are held together by weak van der Waals forces.

“Acylamino” means an R—C(═O)—NH— group in which the R group may be an alkyl, cycloalkyl, heterocycloalkyl, aryl or heteroaryl group as defined herein. The group may be a terminal group or a bridging group. If the group is a terminal group it is bonded to the remainder of the molecule through the nitrogen atom.

“Acyloxy” means an R—C(═O)—O— group in which the R group may be an alkyl, alkenyl, alkynyl, cycloalkyl, heterocycloalkyl, aryl or heteroaryl group as defined herein. The group may be a terminal group or a bridging group. If the group is a terminal group, it is bonded to the remainder of the molecule through the oxygen atom.

“Amino” may refer to groups of the form —NRₐR_{b} wherein Rₐ and R_{b}, may be individually selected from the group including but not limited to hydrogen, optionally substituted alkyl, optionally substituted alkenyl, and optionally substituted alkynyl groups. The amino may be NH₂.

“Aminoalkyl” means an NH₂-alkyl-group in which the alkyl group is as defined herein. The group may be a terminal group or a bridging group. If the group is a terminal group it is bonded to the remainder of the molecule through the alkyl group. “Alkyl” as a group or part of a group may refer to a straight or branched aliphatic hydrocarbon group, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

“Alkenyl” as a group or part of a group may denote an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

“Alkynyl” as a group or part of a group may mean an aliphatic hydrocarbon group containing a carbon-carbon triple bond and which may be straight or branched preferably having from 2-12 carbon atoms, more preferably 2-10 carbon atoms, more preferably 2-6 carbon atoms in the normal chain. Exemplary structures include, but are not limited to, ethynyl and propynyl. The group may be a terminal group or a bridging group.

“Alkyloxy” refers to an alkyl-O-group in which alkyl is as defined herein. Preferably the alkyloxy is a C₁-C₆alkyloxy. Examples include, but are not limited to, methoxy and ethoxy. The group may be a terminal group or a bridging group.

“Alkenyloxy” refers to an alkenyl-O-group in which alkenyl is as defined herein. Preferred alkenyloxy groups are C₁-C₆ alkenyloxy groups. The group may be a terminal group or a bridging group.

If the group is a terminal group it is bonded to the remainder of the molecule through the oxygen atom.

“Alkynyloxy” refers to an alkynyl-O-group in which alkynyl is as defined herein. Preferred alkynyloxy groups are C₁-C₆ alkynyloxy groups. The group may be a terminal group or a bridging group. If the group is a terminal group, it is bonded to the remainder of the molecule through the oxygen atom.

“Alkylamino” includes both mono-alkylamino and dialkylamino, unless specified. “Mono-alkylamino” means an Alkyl-NH-group, in which alkyl is as defined herein.

“Dialkylamino” means a (alkyl)₂N-group, in which each alkyl may be the same or different and are each as defined herein for alkyl. The alkyl group is preferably a C₁-C₆ alkyl group. The group may be a terminal group or a bridging group. If the group is a terminal group it is bonded to the remainder of the molecule through the nitrogen atom.

“Acrylate” refers to a CH₂═CHCOO-group in which alkyl is as defined herein. The group may be a terminal group or a bridging group.

“Alkylacrylate” refers to an alkyl-CH═CHCOO-group in which alkyl is as defined herein. Preferably the alkylacrylate is a C₁-C₆alkylacrylate. Examples include, but are not limited to, methacrylate or ethacrylate. The group may be a terminal group or a bridging group.

“Cycloalkyl” refers to a saturated monocyclic or fused or spiro polycyclic, carbocycle preferably containing from 3 to 9 carbons per ring, such as cyclopropyl, cyclobutyl, cyclopentyl, cyclohexyl and the like, unless otherwise specified. It includes monocyclic systems such as cyclopropyl and cyclohexyl, bicyclic systems such as decalin, and polycyclic systems such as adamantane. A cycloalkyl group typically is a C₃-C₁₂ alkyl group. The group may be a terminal group or a bridging group.

“Cycloalkenyl” means a non-aromatic monocyclic or multicyclic ring system containing at least one carbon-carbon double bond and preferably having from 5-10 carbon atoms per ring. Exemplary monocyclic cycloalkenyl rings include cyclopentenyl, cyclohexenyl or cycloheptenyl. The cycloalkenyl group may be substituted by one or more substituent groups. A cycloalkenyl group typically is a C₃-C₁₂ alkenyl group. The group may be a terminal group or a bridging group.

“Halogen” represents chlorine, fluorine, bromine or iodine.

“Heteroalkyl” refers to a straight- or branched-chain alkyl group preferably having from 2 to 12 carbons, more preferably 2 to 6 carbons in the chain, one or more of which has been replaced by a heteroatom selected from S, O, P and N. Exemplary heteroalkyls include alkyl ethers, secondary and tertiary alkyl amines, amides, alkyl sulfides, and the like. Examples of heteroalkyl also include hydroxyC₁-C₆alkyl, C₁-C₆alkyloxyC₁-C₆alkyl, aminoC₁-C₆alkyl, C₁-C₆alkylaminoC₁-C₆alkyl, and di(C₁-C₆alkyl)aminoC₁- C₆alkyl. The group may be a terminal group or a bridging group.

“Heteroalkenyl” refers to a straight- or branched-chain alkenyl group preferably having from 2 to 12 carbons, more preferably 2 to 6 carbons in the chain, one or more of which has been replaced by a heteroatom selected from S, O, P and N. Exemplary heteroalkenyls include alkenyl ethers, secondary and tertiary alkenyl amines, amides, alkenyl sulfides, and the like. Examples of heteroalkenyl also include hydroxyC₁-C₆alkenyl, C₁-C₆alkyloxyC₁-C₆alkenyl, aminoC₁-C₆alkenyl, C₁-C₆alkylaminoC₁-C₆alkenyl, and di(C₁-C₆alkyl)aminoC₁-C₆alkenyl. The group may be a terminal group or a bridging group.

“Heteroalkynyl” refers to a straight- or branched-chain alkenyl group preferably having from 2 to 12 carbons, more preferably 2 to 6 carbons in the chain, one or more of which has been replaced by a heteroatom selected from S, O, P and N. Exemplary heteroalkynyls include alkynyl ethers, secondary and tertiary alkynyl amines, amides, alkynyl sulfides, and the like. Examples of heteroalkynyl also include hydroxyC₁-C₆alkynyl, C₁-C₆alkyloxyC₁-C₆alkynyl, aminoC₁-C₆alkynyl, C₁-C₆alkylaminoC₁-C₆alkynyl, and di(C₁-C₆alkyl)aminoC₁-C₆alkynyl. The group may be a terminal group or a bridging group.

“Heterocycloalkyl” refers to a saturated monocyclic, bicyclic, or polycyclic ring containing at least one heteroatom selected from nitrogen, sulfur, oxygen, preferably from 1 to 3 heteroatoms in at least one ring. Each ring is preferably from 3 to 10 membered, more preferably 4 to 7 membered. Examples of suitable heterocycloalkyl substituents include pyrrolidyl, tetrahydrofuryl, tetrahydrothiofuranyl, piperidyl, piperazyl, tetrahydropyranyl, morphilino, 1,3-diazapane, 1,4-diazapane, 1,4-oxazepane, and 1,4-oxathiapane. A heterocycloalkyl group typically is a C₂-C₁₂ heterocycloalkyl group. A heterocycloalkyl group may comprise 3 to 8 ring atoms. A heterocycloalkyl group may comprise 1 to 3 heteroatoms independently selected from the group consisting of N, O and S. The group may be a terminal group or a bridging group.

“Heterocycloalkenyl” refers to a heterocycloalkyl as defined herein but containing at least one double bond. A heterocycloalkenyl group typically is a C₂-C₁₂ heterocycloalkenyl group. The group may be a terminal group or a bridging group.

“Hydroxyalkyl” may refer to an alkyl group as defined herein in which one or more of the hydrogen atoms has been replaced with an OH group. An hydroxyalkyl group typically has the formula CₚH₍₂ₛₚ₊₁₋ₓ₎(OH)ₓ. In groups of this type, n is typically from 1 to 10, more preferably from 1 to 6, most preferably from 1 to 3. x is typically from 1 to 6, more preferably from 1 to 4.

The term “optionally substituted” as used herein means the group to which this term refers may be unsubstituted, or may be substituted with one or more groups independently selected from alkyl, alkenyl, alkynyl, cycloalkyl, cycloalkylalkyl, cycloalkenyl, cycloalkylalkenyl, heterocycloalkyl, cycloalkylheteroalkyl, cycloalkyloxy, cycloalkenyloxy, cycloamino, halo, carboxyl, haloalkyl, haloalkenyl, haloalkynyl, alkynyloxy, heteroalkyl, heteroalkyloxy, hydroxyl, hydroxyalkyl, alkyloxy, alkenyloxy, nitro, amino, alkylamino, dialkylamino, alkenylamine, aminoalkyl, alkynylamino, acyl, alkyloxy, alkyloxyalkyl, alkyloxyaryl, alkyloxycarbonyl, alkyloxycycloalkyl, alkyloxyheteroaryl, alkyloxyheterocycloalkyl, acylamino, alkylsulfonyloxy, heterocyclic, heterocycloalkenyl, heterocycloalkyl, heterocycloalkylalkyl, heterocycloalkylalkenyl, heterocycloalkylheteroalkyl, heterocycloalkyloxy, heterocycloalkenyloxy, heterocycloamino, haloheterocycloalkyl, alkylsulfinyl, alkylsulfonyl, aminosulfonyl, sulfinyl, sulfinylamino, sulfonyl, sulfonylamino, aryl, heteroaryl, heteroarylalkyl, heteroarylalkenyl, heteroarylheteroalkyl, heteroarylamino, heteroaryloxy, arylalkenyl, arylalkyl, aryloxy, arylsulfonyl, cyano, cyanate, isocyanate, —C(O)NH(alkyl), and —C(O)N(alkyl)₂.

In the definitions of a number of substituents, it is stated that “the group may be a terminal group or a bridging group”. This is intended to signify that the use of the term is intended to encompass the situation where the group is a linker between two other portions of the molecule as well as where it is a terminal moiety. Using the term alkyl as an example, some publications would use the term “alkylene” for a bridging group and hence in these other publications there is a distinction between the terms “alkyl” (terminal group) and “alkylene” (bridging group). In the present application, no such distinction is made and most groups may be either a bridging group or a terminal group.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### Composite Material

Exemplary, non-limiting embodiments of a composite material will now be disclosed.

A composite material may comprise a thermally conductive component coated with a surface modified nitride, wherein the nitride is surface modified with at least one silane compound having the following formula (I):

R¹—(X¹)ₙ—(CR³R⁴)ₘ—Si(—O—R²)₃ (I)

wherein R¹ may be selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y}; each occurrence of R² may be independently selected from the group consisting of hydrogen, optionally substituted alkyl and silane ester;

each occurrence of R³ and R⁴ are independently hydrogen or optionally substituted alkyl;

each occurrence of X¹ or X² may be linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n may be independently any integer from 0 to 6; and

y may be any integer from 1 to 200.

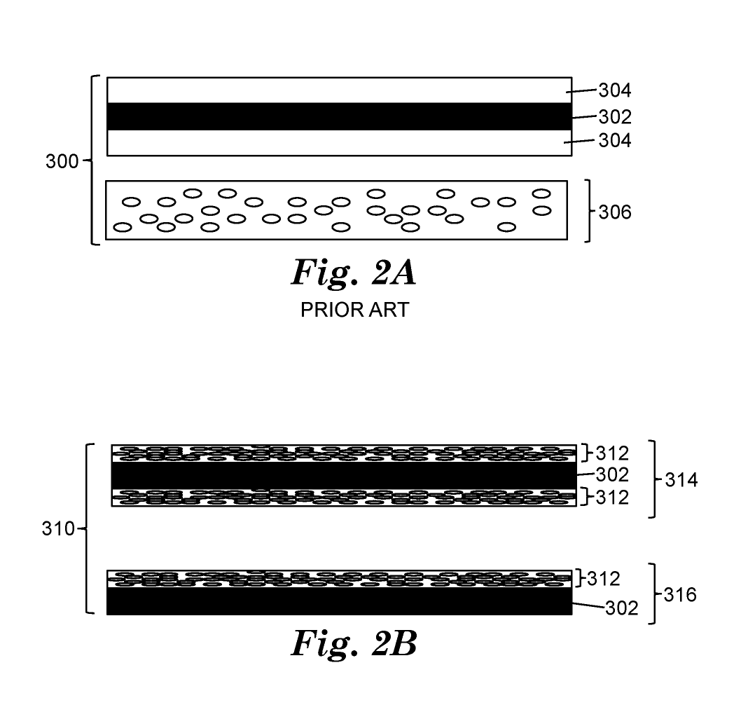

A pictorial representation of the composite material of the present disclosure (310) is shown in FIG. 2B. In comparison, existing products (300) such as graphite films with an adhesive and adhesive transfer tapes filled with thermal conductive particles is shown in FIG. 2A. An example of a conventional product is where an adhesive (304) is used to bond the graphite (302) to a heat source and/or heat sink. Another example of a conventional product is an adhesive containing a filler such as BN or Al₂O₃ (306) that is used to bond graphite (302) to a substrate. For the composite material of the present disclosure (310), surface modified h-BN (312) replaces the adhesive used in conventional products on both sides (314) of the graphite film (302) or on one side (316) of the graphite film (302).

The nitride may be a nitride of a group 13 element. The group 13 element may be selected from the group consisting of boron, aluminium, gallium, indium and thallium. The nitride of the group 13 element may be selected from the group consisting of boron nitride, aluminium nitride, gallium nitride, indium nitride and thallium nitride.

The group 13 element may be boron or aluminium. The nitride of the group 13 element may be boron nitride or aluminium nitride.

Boron nitride may provide higher thermal conductivity than Al₂O₃.

The boron nitride may be hexagonal boron nitride (h-BN).

h-BN may be structurally very similar to a graphene sheet having a hexagonal backbone where each couple of bonded carbon atoms is replaced by a boronnitride pair, making the two materials isoelectronic. Nevertheless, due to the electro-negativity differences between the boron and the nitrogen atoms, the π electrons tend to localize around the nitrogen atomic centers, thus forming an insulating material.

Advantageously, h-BN may have a crystal structure similar to that of graphite, providing excellent lubricating properties. In addition, h-BN may have unique properties such as high thermal conductivity, low thermal expansion, good thermal shock resistance, high electrical resistance, low dielectric constant, non-toxicity, easy machinability and chemical inertness.

n may be an integer from 0 to 6. n may be 0, 1, 2, 3, 4, 5 or 6. n maybe 0, 1 or 2. When n is 0, X¹ is absent.

m may be an integer from 0 to 6. m may be 0, 1, 2, 3, 4, 5 or 6. m may be 0, 2 or 3. When m is 0, (CR³R⁴) is absent.

R¹ may be selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl and —(C(X²)₂)_{y}.

R¹ may be selected from the group consisting of halogen, thiol, optionally substituted alkyl, optionally substituted amino, optionally substituted cycloalkyl, optionally substituted heterocycloalkyl, and optionally substituted acyloxy and —(C(X²)₂)_{y}.

R¹ may be selected from the group consisting of thiol, C₃ to C₇ heterocycloalkyl, C₁ to C₅ aminoalkyl, C₁ to C₅ dialkylamino, C₁ to C₅ hydroxyalkyl, acrylate, C₃ to C₈ alkylacrylate and —(C(X²)₂)_{y},

The halogen may be selected from the group consisting of fluorine, chlorine, bromine and iodine.

The thiol may be a sulfhydryl or SH.

The cyclic ether may be selected from the group consisting of oxirane (ethylene oxide), dioxane, and tetrahydrofuran.

The hydroxyalkyl may be selected from the group consisting of methanol, ethanol, propanol, butanol, pentanol, 1,2-ethanediol, 1,2-propanediol, 1,2-butanediol, 2,3-butanediol, 1,2-pentanediol and 2,3-pendanediol.

The cyclic ether may be oxirane or the hydroxyalkyl may be 1,2-ethanediol. The oxirane may undergo a ring opening reaction to form the 1,2-ethandiol.

R¹ may be selected from the group consisting of —SH, oxirane, 3,4-epoxycyclohexyl, 1-aminoisopropyl, diethylamino, methacrylate, 1,2-ethanediol and poly(1,2-butadiene).

Each occurrence of X¹ may be a bond or an optionally substituted heteroalkyl.

Each occurrence of X¹ may be a bond, optionally substituted alkyloxy or an optionally substituted alkylamino.

X¹ may be selected from the group consisting of —(CH₂—O)—, —(CH(CH₃))—, —(CH₂NH)— and any combination thereof.

n may be 1 and X¹ may be —(CH₂—O)—.

n may be 3 and each occurrence of X¹ may independently be —(CH₂—O)—, —(CH(CH₃))— and —(CH₂NH)— in any order.

n may be 3 and (X¹)₃ may be —CH₂—O—CH(CH₃)—(CH₂NH)—.

The silane compound may have the following formula (Ia):

R¹—(CH₂—O)ₙ—(CR³R⁴)ₘ—Si(—O—R²)₃ (Ia)

wherein n may be 0 or 1,

m may be any integer from 0 to 6;

R¹ may be selected from the group consisting of halogen, thiol, optionally substituted alkyl, optionally substituted amino, optionally substituted cycloalkyl, optionally substituted heterocycloalkyl, and optionally substituted acyloxy.

Each occurrence of R³ and R⁴ may be independently hydrogen or methyl. R³ and R⁴ may both be hydrogen. When m is 1, CR³R⁴ may be methyl, when m is 2, (CR³R⁴)₂ may be ethyl and when m is 3, (CR³R⁴)₃ may be propyl.

Each occurrence of R² may independently be selected from the group consisting of hydrogen, optionally substituted alkyl and silane ester. Each occurrence of R² may independently be an optionally substituted C₁ to C₅alkyl. Each occurrence of R² may independently be optionally substituted methyl, optionally substituted ethyl, optionally substituted straight or branched propyl, optionally substituted straight or branched butyl or optionally substituted straight or branched pentyl. R² may be methyl. R² may be a silane ester.

The group —Si(—O—R²)₃ may be Si(—O—H)₃, Si(—O—Me)₃, Si(—O—Et)₃, Si(—O—H)₂(—O—Me), Si(—O—H)₂(—O—Et), Si(—O—Me)₂(O—H), Si(—O—Et)₂(O—H), —Si(—O—Me)₂(—O—Et), —Si(—O—Et)₂(—O—Me) or Si(—O—H) (—O—Me)(—O—Et).

The silane compound may have the following formula (Ib) to (Ie):

R¹—(CH₂—O)ₙ—(CH₂)ₘ—Si(—O—R²)₃, (Ib)

R¹—(CH₂—O)ₙ—(CH(CH₃))ₘ—Si(—O—R²)₃, (Ic)

R¹—(CH₂—O)ₙ—(CH₂)ₘ—Si(—O—Si—(CH₂)ₘ—(CH₂—O)ₙ—R¹)₃; (Id)

R¹—(CH₂—O)ₙ—(CH(CH₃))ₘ—Si(—O—Si—(CH(CH₃))ₘ13 (CH₂—)ₙ—R¹)₃; (Ic)

and any mixture thereof, wherein each occurrence of R² may be independently selected from hydrogen, methyl or ethyl.

The silane groups may be cross-linked to form polysiloxanes. The surface modified nitride may comprise silane groups, polysiloxane groups and mixtures thereof.

The trimethoxysilane may be hydrolysed to trihydroxysilane, which may then undergo cross-linking to form a polysiloxane.

Each occurrence of X² may be independently selected from the group consisting of a bond or optionally substituted alkyl.

X² may have the formula —(CH₂)ₚ—CHR⁵—, wherein R⁵ may be selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl and optionally substituted heterocycloalkenyl; and p is 0 or 1.

R⁵ may be an optionally substituted C₂ to C₅ alkenyl. R⁵ may be —CH═CH₂. The silane compound of formula (I) may be selected from the group consisting of epoxy functional silane, amino functional silane, polymeric silane and methacrylate functional silane. The silane compound of formula (I) may be selected from the group consisting of 3-glycidoxypropyltrimethoxysilane, 3-glycidoxypropyltriethoxysilane, 5,6-epoxyhexyltriethoxysilane, 3-glycidoxypropylmethyldiethoxysilane, 3-glycidoxypropylmethyldimethoxysilane, 3-glycidoxypropyldimethylethoxysilane, 2-(3,4-epoxycyclohexyl)ethyltriethoxysilane, 2-(3,4-epoxycyclohexyl)ethyltrimethoxysilane, 3-aminopropyltrimethoxysilane, [3-(diethylamino)propyl]trimethoxysilane, N-3-Ramino(polypropylenoxy)laminopropyltrimethoxysilane, (diethylamino)trimethylsilane, triethoxysilyl modified poly-1,2-butadiene, trimethoxysilyl modified poly-1,2-butadiene, diethoxymethylsilyl modified poly-1,2-butadiene, triethoxysilylethyl(ethylene-1,4 butadiene-styrene) terpolymer, 3-methacryloxypropyltrimethoxysilane, 3-mercaptopropyltrimethoxysilane (MPTMS) and 3-mercaptopropyltriethoxysilane.

The nitride may be surface modified with at least two different silane compounds of formula (I).

The silane compound of formula (I) may be selected from the group consisting of 3-glycidoxypropyltrimethoxysilane (GPTMS), 3-mercaptopropyltrimethoxysilane (MPTMS) and any mixture thereof.

The nitride to silane ratio may be selected such that the silane content is sufficiently high for the purposes of surface modifying the nitride, but also act as a good bonding agent or adhesive between the nitride thermal insulating material layer and the heat source/heat sink.

The ratio between the nitride and the at least one silane compound having the formula (I) may be in the range of about 1:1 to about 1:5, about 1:1 to about 1:1.5, about 1:1 to about 1:2, about 1:1 to about 1:2.5, about 1:1 to about 1:3, about 1:1 to about 1:3.5, about 1:1 to about 1:4, or about 1:1 to about 1:4.5, about 1:1.5 to about 1:2, about 1:1.5 to about 1:2.5, about 1:1.5 to about 1:3, about 1:1.5 to about 1:3.5, about 1:1.5 to about 1:4, about 1:1.5 to about 1:4.5, about 1:1.5 to about 1:5, about 1:2 to about 1:2.5, about 1:2 to about 1:3, about 1:2 to about 1:3.5, about 1:2 to about 1:4, about 1:2 to about 1:4.5, about 1:2 to about 1:5, about 1.2.5 to about 1:3, about 1:2.5 to about 1:3.5, about 1:2.5 to about 1:4, about 1:2.5 to about 1:3, about 1:2.5 to about 1:3.5, about 1:2.5 to about 1:4, about 1:2.5 to about 1:4.5, about 1:2.5 to about 1:5, about 1:3 to about 1:3.5, about 1:3 to about 1:4, about 1:3 to about 1:4.5, about 1:3 to about 1:5, about 1:3.5 to about 1:4, about 1:3.5 to about 1:4.5, about 1:3.5 to about 1:5, about 1:4 to about 1:4.5, about 1:4 to about 1:5 or about 1:4.5 to about 1:5. The ratio between the nitride and the at least one silane compound having the formula (I) may be about 1:1.5. The ratio of about 1:1.5 between the nitride and the at least one silane compound having the formula (I) may confer advantageous adhesive properties to the surface modified nitride.

The nitride may be surface modified with at least one silane compound of formula (I). The nitride may be surface modified with at least two silane compounds of formula (I). The nitride may be surface modified with at least three silane compounds of formula (I). The nitride may be surface modified with at least four silane compounds of formula (I). When the nitride is surface modified with more than one silane compound of formula (I), each silane compound of formula (I) may be different from one other.

The thermally conductive component may be in the form of a sheet.

The thermally conductive component in the form of a sheet may have a thickness in the range of about 10 μm to about 50 μm, about 10 μm to about 15 μm, about 10 μm to about 20 μm, about 10 μm to about 25 μm, about 10 μm to about 30 μm, about 10 μm to about 40 μm, about 10 μm to about 45 μm, about 15 μm to about 20 μm, about 15 μm to about 25 μm, about 15 μm to about 30 μm, about 15 μm to about 35 μm, about 15 μm to about 40 μm, about 15 μm to about 45 μm, about 15 μm to about 50 μm, about 20 μm to about 25 μm, about 20 μm to about 30 μm, about 20 μm to about 35 μm, about 20 μm to about 40 μm, about 20 μm to about 45 μm, about 20 μm to about 50 μm, about 25 μm to about 30 μm, about 25 μm to about 35 μm, about 25 μm to about 40 μm, about 25 μm to about 45 μm, about 25 μm to about 50 μm, about 30 μm to about 35 μm, about 30 μm to about 40 μm, about 30 μm to about 45 μm, about 30 μm to about 50 μm, about 35 μm to about 40 μm, about 35 μm to about 45 μm, about 35 μm to about 50 μm, about 40 μm to about 45 μm, about 40 μm to about 50 μm or about 45 μm to about 50 μm. The thermally conductive component may have a thickness of about 25 μm.

The thermally conductive component may be graphite. The thermally conductive component may be a graphite sheet.

Graphite sheets are graphite flakes processed into sheets by the combination of chemical, thermal and mechanical treatment, as a thermal interface material is gaining importance due to the advantages it has. For example, graphite has good bulk thermal conductivity, it does not pump out like greases and gels and further no curing is needed as in the case of elastomer films. Another major advantage of graphite is that it can be processed into sheet form which is much more easily adapted into the manufacturing processes. Further, it can be coated with a binding layer (for adhesion) to adhere it with the heat source and the heat sink.

The thermally conductive component may be coated with the surface modified nitride on one side of the sheet or on both sides of the sheet.

The coating of the surface modified nitride or the layer of surface modified nitride coated on the thermally conductive component may have a thickness in the range of about 1 μm to about 20 μm, about 1 μm to about 5 μm, about 1 μm to about 10 μm, about 1 μm to about 15 μm, about 5 μm to about 10 μm, about 5 μm to about 15 μm, about 5 μm to about 20 μm, about 10 μm to about 15 μm, about 10 μm to about 20 μm, about 15 μm to about 20 μm, about 8 μm to about 12 μm, about 8 μm to about 9 μm, about 8 μm to about 10 μm, about 8 μm to about 11 μm, about 9 μm to about 10 μm, about 9 μm to about 11 μm, about 9 μm to about 12 μm, about 10 μm to about 11 μm, about 10 μm to about 12 μm or about 11 μm to about 12 μm. The coating of the surface modified nitride or the layer of surface modified nitride coated on the thermally conductive component may have a thickness in the range of about 9 μm to about 11 μm.

The composite material may have a thickness in the range of 10 μm to about 250 μm, about 10 μm to about 20 μm, about 10 μm to about 30 μm, about 10 μm to about 40 μm, about 10 μm to about 50 μm, about 10 μm to about 75 μm, about 10 μm to about 100 μm, about 10 μm to about 150 μm, about 10 μm, to about 200 μm, about 20 μm to about 30 μm, about 20 μm to about 40 μm, about 20 μm to about 50 μm, about 20 μm to about 75 μm, about 20 μm to about 100 μm, about 20 μm to about 150 μm, about 20 μm to about 200 μm, about 20 μm to about 250 μm, about 30 μm to about 40 μm, about 30 μm to about 50 μm, about 30 μm to about 75 μm, about 30 μm to about 100 μm, about 30 μm to about 150 μm, about 30 μm to about 200 μm, about 30 μm to about 250 μm, about 40 μm to about 50 μm, about 40 μm to about 75 μm, about 40 μm to about 100 μm, about 40 μm to about 150 μm, about 40 μm to about 200 μm, about 40 μm to about 250 μm, about 50 μm to about 75 μm, about 50 μm to about 100 μm, about 50 μm to about 150 μm, about 50 μm to about 200 μm, about 50 μm to about 250 μm, about 75 μm to about 100 μm, about 75 μm to about 150 μm, about 75 μm to about 200 μm, about 75 μm to about 250 μm, about 100 μm to about 150 μm, about 100 μm to about 200 μm, about 100 μm to about 250 μm, about 150 μm to about 200 μm, about 150 μm to about 250 μm, or about 200 μm to about 250 μm.

The composite material may be substantially free of any adhesives other than the surface modified nitride.

The composite material may consist essentially of a thermally conductive component coated with a surface modified nitride, wherein the nitride may be surface modified with at least one silane compound having the following formula (I):

R¹—(X¹)ₙ—(CR³R⁴)ₘ—Si(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl; each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.

A method for synthesizing a composite material may comprise the steps of: contacting a nitride and at least one compound having the following formula (I):

R¹—(X¹)ₙ—(CR³R⁴)ₘ—Si(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl;

each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.The contacting step may comprise a solvent. The solvent may be an ether, alcohol or ketone. The solvent may be a glycol ether or 1-methoxy-2-propanol. 1-methoxy 2-propanol may be particularly advantageous to use as a solvent due to its higher polarity where the inorganic particles such as the h-BN may be easily dispersed and it has a higher boiling point (118° C.).

The ratio between the solvent and the surface modified nitride may be in the range of about 1:1 to about 100:1, about 1:1 to about 5:1, about 1:1 to about 10:1, about 1:1 to about 20:1, about 1:1 to about 50:1, about 5:1 to about 10:1, about 5:1 to about 50:1, about 5:1 to about 500:1, about 10:1 to about 50:1, about 10:1 to about 100:1 or about 50:1 to about 100:1.

The contacting step may comprise an acid. The acid may be sulphuric acid or H₂SO₄. The acid may be 20% H₂SO₄.

The nitride and the at least one compound having the formula (I) may be contacted at a ratio in the range of about 1:1 to about 1:5, about 1:1 to about 1:1.5, about 1:1 to about 1:2, about 1:1 to about 1:2.5, about 1:1 to about 1:3, about 1:1 to about 1:3.5, about 1:1 to about 1:4, or about 1:1 to about 1:4.5, about 1:1.5 to about 1:2, about 1:1.5 to about 1:2.5, about 1:1.5 to about 1:3, about 1:1.5 to about 1:3.5, about 1:1.5 to about 1:4, about 1:1.5 to about 1:4.5, about 1:1.5 to about 1:5, about 1:2 to about 1:2.5, about 1:2 to about 1:3, about 1:2 to about 1:3.5, about 1:2 to about 1:4, about 1:2 to about 1:4.5, about 1:2 to about 1:5, about 1.2.5 to about 1:3, about 1:2.5 to about 1:3.5, about 1:2.5 to about 1:4, about 1:2.5 to about 1:3, about 1:2.5 to about 1:3.5, about 1:2.5 to about 1:4, about 1:2.5 to about 1:4.5, about 1:2.5 to about 1:5, about 1:3 to about 1:3.5, about 1:3 to about 1:4, about 1:3 to about 1:4.5, about 1:3 to about 1:5, about 1:3.5 to about 1:4, about 1:3.5 to about 1:4.5, about 1:3.5 to about 1:5, about 1:4 to about 1:4.5, about 1:4 to about 1:5 or about 1:4.5 to about 1:5. The nitride and the at least one compound having the formula (I) may be contacted at a ratio of about 1:1.5.

The contacting step may comprise contacting at least one silane compound of formula (I) with the nitride. The contacting step may comprise contacting at least two silane compounds of formula (I) with the nitride. The contacting step may comprise contacting at least three silane compounds of formula (I) with the nitride. The contacting step may comprise contacting at least four silane compounds of formula (I) with the nitride. When the nitride is surface modified with more than one silane compound of formula (I), each silane compound of formula (I) may be different from one other.

The contacting step may be performed at a temperature in the range of about 40° C. to about 120° C., about 40° C. to about 60° C., about 40° C. to about 80° C., about 40° C. to about 100° C., about 60° C. to about 80° C., about 60° C. to about 100° C., about 60° C. to about 120° C., about 80° C. to about 100° C., about 80° C. to about 120° C. or about 100° C. to about 120° C.

The contacting step may be performed for a duration of about 6 hours to about 15 hours, about 6 hours to about 9 hours, about 6 hours to about 12 hours, about 9 hours to about 12 hours, about 9 hours to about 15 hours or about 12 hours to about 15 hours.

The contacting step may comprise mixing. The mixing may be physical mixing. The physical mixing may be performed using a stir bar. The mixing using the stir bar may be performed at a rotational frequency in the range of about 300 rpm to about 800 rpm, about 300 rpm to about 500 rpm or about 500 rpm to about 800 rpm.

The coating step may comprise coating the thermally conductive component with the surface modified nitride on one side of the sheet or on both sides of the sheet. The surface modified nitride may be in the form of a solution in the solvent prior to coating. The solution of the surface modified nitride may have a concentration in the range of about 0.5 wt % to about 5 wt %, about 0.5 wt % to about 1 wt %, 0.5 wt % to about 2 wt %, about 1 wt % to about 2 wt %, about 1 wt % to about 2 wt %, about 1 wt % to about 5 wt % or about 2 wt % to about 5 wt %.

The thermally conductive component may be coated with the solution of the surface modified nitride at a thickness in the range of about 5 μm to about 100 μm, about 5 μm to about 10 μm about 5 μm to about 20 μm, about 5 μm to about 50 μm, about 10 μm to about 20 μm, about 10 μm to about 50 μm, about 10 μm to about 100 μm, about 20 μm to about 50 μm, about 20 μm to about 100 μm or about 50 μm to about 100 μm.

The method may further comprise the step of drying the composite material after the coating step. The drying step may remove the excess solvent.

The drying step may be performed at a temperature in the range of about 50° C. to about 120° C., about 50° C. to about 70° C., about 50° C. to about 90° C., about 70° C. to about 90° C., about 70° C. to about 120° C. or about 90° C. to about 120° C.

The drying step may be performed for a duration in the range of about 5 minutes to about 30 minutes, about 5 minutes to about 10 minutes, about 5 minutes to about 15 minutes, about 10 minutes to about 15 minutes, about 10 minutes to about 30 minutes or about 15 minutes to about 30 minutes.

The method may not require the use of adhesives other than the surface modified nitride.

A method for synthesizing a composite material may consist essentially of the steps of:

contacting a nitride and at least one compound having the following formula (I):

R¹—(X¹)ₙ—(CR³R⁴)ₘ—Si(—O—R²)₃ (I)

wherein R¹ may be selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl or —(C(X²)₂)_{y};

each occurrence of R² may be independently selected from the group consisting of hydrogen, optionally substituted alkyl and silane ester;

each occurrence of R³ and R⁴ may be independently hydrogen or optionally substituted alkyl;

each occurrence of X¹ or X² may be linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n may be independently any integer from 0 to 6; and

y may be any integer from 1 to 200A material obtainable by the method as defined above.

An article comprising a composite material as defined above, bonded onto a heat source, a heat sink or both.

The heat source may be any electronic or mechanical device that generates heat. The heat source may be an LED, CPU, microprocessor, flip chip IC interface to package lids, power semiconductor and module, optical component such as laser diode, multiplexer and transceiver, sensor, power supply, high speed mass storage drive, motor control, high voltage transformer or automotive mechatronics.

The heat sink may comprise aluminium, copper, silver, diamond and any mixture thereof

CPU's and microprocessors, flip chip IC interfaces to package lids, power semiconductors and modules, optical components such as laser diodes, multiplexers and transceivers, sensors, power supplies, high speed mass storage drives, motor controls, high voltage transformers and automotive mechatronics.

Various embodiments are provided.

Embodiment 1 is a composite material comprising a thermally conductive component coated with a surface modified nitride, wherein the nitride is surface modified with at least one silane compound having the following formula (I):

R¹—(X¹)ₙ—(CR³R⁴)ₘ—Si(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl and —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl;

each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.

Embodiment 2 is the composite material of embodiment 1, wherein the nitride is a nitride of a group 13 element.

Embodiment 3 is the composite material of embodiment 2, wherein the group 13 element is selected from the group consisting of boron, aluminium, gallium, indium and thallium.

Embodiment 4 is the composite material of embodiment 3, wherein the group 13 element is boron or aluminium, or the nitride of the group 13 element is boron nitride or aluminium nitride.

Embodiment 5 is the composite material of embodiment 4, wherein the boron nitride is hexagonal boron nitride.

Embodiment 6 is the composite material of any one of the preceding embodiments, wherein each occurrence of X¹ is a bond or an optionally substituted heteroalkyl.

Embodiment 7 is the composite material of embodiment 6, wherein each occurrence of X¹ is a bond, optionally substituted alkyloxy or an optionally substituted alkylamino.

Embodiment 8 is the composite material of any one of the preceding embodiments, wherein the silane compound has the following formula (Ia):

R¹—(CH₂—O)ₙ—(CR³R⁴)ₘ—Si(—O—R²)₃ (Ia)

wherein n is 0 or 1,

m is any integer from 0 to 6; and

R¹ is selected from the group consisting of halogen, thiol, optionally substituted alkyl, optionally substituted amino, optionally substituted cycloalkyl, optionally substituted heterocycloalkyl, optionally substituted acyloxy and —(C(X²)₂)_{y}.

Embodiment 9 is the composite material of any one of the preceding embodiments, wherein each occurrence of R³ and R⁴ are independently hydrogen or methyl.

Embodiment 10 is the composite material of any one of the preceding embodiments, wherein each occurrence of R² is independently hydrogen, an optionally substituted C₁ to C₅ alkyl or a silane ester.

Embodiment 11 is the composite material of any one of the preceding embodiments, wherein the silane compound has the following formula (Ib) to (Ie):

R¹—(CH₂—O)ₙ—(CH₂)ₘ—Si(—O—R²)₃, (Ib)

R¹—(CH₂—O)ₙ—(CH(CH₃))ₘ—Si(—O—R²)₃, (Ic)

R¹—(CH₂—O)ₙ—(CH₂)ₘ—Si(—O—Si—(CH₂)ₘ—(CH₂—)ₙ—R¹)₃; (Id)

R¹—(CH₂—O)ₙ—(CH(CH₃))ₘ—Si(—O—Si—(CH(CH₃))ₘ—(CH₂—O)ₙ—R¹)₃; (Ic)

and any mixture thereof, wherein R² is selected from hydrogen, methyl or ethyl.

Embodiment 12 is the composite material of any one of the preceding embodiments, wherein R¹ is selected from the group consisting of thiol, C₃ to C₇ heterocycloalkyl, C₁ to C₅ aminoalkyl, C₁ to C₅ dialkylamino, C₁ to C₅ hydroxyalkyl, acrylate, C₃ to C₈ alkylacrylate and —(C(X²)²)_{y}.

Embodiment 13 is the composite material of embodiment 12, wherein R¹ is selected from the group consisting of —SH, oxirane, 3,4-epoxycyclohexyl, 1-aminoisopropyl, diethylamino, methacrylate, 1,2-ethanediol, and poly (1,2-butadiene).

Embodiment 14 is the composite material of any one of the preceding embodiments, wherein each occurrence of X² is independently selected from the group consisting of a bond or optionally substituted alkyl.

Embodiment 15 is the composite material of embodiment 14, wherein X² has the formula —(CH₂)ₚ—CHR⁵—, wherein R⁵ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl and optionally substituted heterocycloalkenyl; and p is 0 or 1.

Embodiment 16 is the composite material of embodiment 15, wherein R⁵ is an optionally substituted C₂ to C₅ alkenyl.

Embodiment 17 is the composite material of any one of the preceding embodiments, wherein the silane compound of formula (I) is selected from the group consisting of 3-glycidoxypropyltrimethoxysilane, 3-glycidoxypropyltriethoxysilane, 5,6-epoxyhexyltriethoxysilane, 3-glycidoxypropylmethyldiethoxysilane, 3-glycidoxypropylmethyldimethoxysilane, 3-glycidoxypropyldimethylethoxysilane, 2-(3,4-epoxycyclohexyl)ethyltriethoxysilane, epoxycyclohexypethyltrimethoxysilane, 3-aminopropyltrimethoxysilane, [3-(diethylamino)propyl]trimethoxysilane, N-3-Ramino(polypropylenoxy)laminopropyltrimethoxysilane, (diethylamino)trimethylsilane, triethoxysilyl modified poly-1,2-butadiene, trimethoxysilyl modified poly-1,2-butadiene, diethoxymethylsilyl modified poly-1,2-butadiene, triethoxysilylethyl(ethylene-1,4 butadiene-styrene) terpolymer, 3-methacryloxypropyltrimethoxysilane, 3-mercaptopropyltrimethoxysilane (MPTMS) and 3-mercaptopropyltriethoxysilane.

Embodiment 18 is the composite material of any one of the preceding embodiments, wherein the silane compound of formula (I) is selected from the group consisting of 3-glycidoxypropyltrimethoxysilane (GPTMS), 3-mercaptopropyltrimethoxysilane (MPTMS) and any mixture thereof.

Embodiment 19 is the composite material of any one of the preceding embodiments, wherein the nitride is surface modified with at least two different silane compounds of formula (I).

Embodiment 20 is the composite material of any one the preceding embodiments, wherein the ratio between the nitride and at least one compound having the formula (I) is in the range of 1:1 to 1:5.

Embodiment 21 is the composite material of any one of the preceding embodiments, wherein the thermally conductive component is in the form of a sheet.

Embodiment 22 is the composite material of embodiment 21, wherein the thermally conductive component is coated with the surface modified nitride on one side of the sheet or on both sides of the sheet.

Embodiment 23 is the composite material of any one of the preceding embodiments, wherein the thermally conductive component is graphite.

Embodiment 24 is the composite material of any one of the preceding embodiments, wherein the composite material is substantially free of any adhesives other than the surface modified nitride.

Embodiment 25 is the composite material of any one of the preceding embodiments, wherein the composite material has a thickness in the range of 10 μm to about 250 μm.

Embodiment 26 is a method for synthesizing a composite material of any one of embodiments 1 to 25, comprising the steps of:

contacting a nitride and at least one compound having the following formula (I):

R¹—(X¹)ₙ—(CR³R⁴)ₘ—Si(—O—R²)₃ (I)

wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl and —(C(X²)₂)_{y};

each occurrence of R² is independently selected from the group consisting of hydrogen, optionally substituted alkyl and silane ester;

each occurrence of R³ and R⁴ are independently hydrogen or optionally substituted alkyl;

each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;

m and n are independently any integer from 0 to 6; and

y is any integer from 1 to 200.

Embodiment 27 is the method of embodiment 26, wherein the contacting step comprises a solvent.

Embodiment 28 is the method of embodiment 27, wherein the solvent is an ether, alcohol or ketone.

Embodiment 29 is the method of embodiment 28, wherein the solvent is a glycol ether or 1-methoxy-2-propanol.

Embodiment 30 is the method of any one of embodiments 26 to 29, wherein the contacting step comprises an acid.

Embodiment 31 is the method any one of embodiments 26 to 30, wherein the nitride and the at least one compound having the formula (I) is contacted at a ratio in the range of 1:1 to 1:5.

Embodiment 32 is the method of any one of embodiments 26 to 31, wherein the contacting step comprises contacting at least two silane compounds of formula (I) with the nitride.

Embodiment 33 is the method of any one of embodiments 26 to 32, wherein the thermally conductive component is a sheet.

Embodiment 34 is the method of embodiment 33, wherein the coating step comprises coating the thermally conductive component with the surface modified nitride on one side of the sheet or on both sides of the sheet.

Embodiment 35 is the method of any one of embodiments 26 to 34, wherein the method does not require the use of adhesives other than the surface modified nitride.

Embodiment 36 is a material obtainable by the method of any one of embodiments 26 to 35.

Embodiment 37 is an article comprising a composite material of any one of embodiments 1 to 25, bonded onto a heat source, a heat sink or both.

### EXAMPLES

Non-limiting examples of the invention will be further described in greater detail by reference to specific Examples, which should not be construed as in any way limiting the scope of the invention.

### Materials

h-BN was procured from Ceradyne, Inc., a 3M Company (USA) (SCP-1 with a mean particle size of 0.5 μm with hexagonal structure, h-BN) and the silanes such as 3-glycidoxypropyl trimethoxy silane, 3-mercaptopropyl triethoxysilane and 2-(aminoethylamino propyl)trimethoxy silanes were procured from Gelest Inc. (USA). The graphite sheets with and without adhesive were obtained from Advanced Energy Technology Inc. (A GrafTech International Ltd. Co., USA) and Panasonic Inc. (USA). Typically, the graphite film was of 25 μm thickness. The graphite sheet with adhesive was obtained in the form of 25 μm thickness graphite film coated with pressure sensitive adhesive to 10 μm thickness on either one of the sides or on two sides. For comparative studies, 3M™ Thermally Conductive Adhesive Transfer Tape 8805 (5 mm thickness) was used.

The LED package for thermal resistivity measurements were obtained from CREE, Inc. (USA). The construction is such that 1W LED on a die was mounted over a ceramic substrate with lead (Pb) solder pre-form at the bottom to form the package. The thermal resistivity measurements were carried out by bonding the surface modified BN layer on graphite film with the solder pre-form at the bottom of the package.

### Example 1

### General Experimental Procedure

For the present study, the h-BN was subjected to surface modification, coated on graphite film as a layer and subjected to thermal conductivity and thermal resistance measurements. A representative synthetic procedure is described as follows:

1. Surface Modification of h-BN

The h-BN powder was mixed with different amounts of silane and mixed in a glass bottle using 1-methoxy 2-propanol as the solvent. The h-BN to silane ratios and the type of silane used was varied as shown in Tables 1 to 3. Different weight ratios of silane to BN were used to study the effect of silane content on the surface modification of BN, adhesion with aluminium and/or graphite, and the interface thermal resistance.

The BN with different charges of silane were mixed in a glass bottle using a stir bar at 500 rpm speed and 80° C. in an oil bath for 12 hours. Typically, the mixing was carried out with additions of 1 g of 1-methoxy-2-propanol per 0.1g of BN after acidifying with a drop of 20% H₂SO₄. After mixing, the solutions were further diluted with 1-methoxy-2-propanol, to obtain an approximately 2wt % BN solution.

2. Formation of Surface Modified BN Layer on Graphite Film

The surface modified BN was coated on graphite films using a notch bar with different slot dimensions. Typically, to obtain a 10 μm dry film thickness, a 4 mm notch bar was used. Once coated, the graphite film was dried at 70° C. for 15 min to remove the excess solvent.

To measure the thermal conductivity of the surface modified BN by Dyn-TIM, the 2wt % BN solution was coated on graphite films to different thicknesses ranging from 10-60 μm. For the present study, the thermal conductivity measurements were limited to materials having a BN to silane ratio of 1:1.5 as this condition gave very good adhesion of the surface modified BN to graphite and aluminium.

For thermal resistivity measurements, the surface modified BN thickness was maintained at about 10±1 μm. This was in order to make a direct comparison between graphite films having a surface modified BN layer with graphite films having 10 μm thick adhesive.

3. Dyn-TIM Thermal Conductivity and T3 Ster Thermal Resistance Measurements

The thermal conductivity and thermal resistance measurements of h-BN layer on graphite films was carried out using a Dynamic thermal characterization of thermal interface materials (DynTIM) equipment supplied by Mentor Graphics, Inc., (Oreg., USA). For thermal resistance measurements of the material on an operating LED package, a thermal transient tester (T3 Ster pronounced as trister) from Mentor Graphics Inc., was used.

The DynTIM measurement to study the thermal conductivity was carried out using different BN coatings of varying thickness on graphite film. The thermal conductivity was calculated from the slope of measured thermal resistance as a function of bond length thickness.

The thermal resistance measurements were carried out using the LED package in the T3Ster equipment. The LED package with Pb solder pre-form at the bottom was bonded with surface modified BN coated graphite film by hand pressing. This was heat cured at 100° C. for 15 minutes for improved adhesion.

To compare different TIM materials, the thermal resistance measurements were carried out on (i) thermal grease, (ii) graphite film with adhesive and (ii) graphite film with surface modified BN. Prior to measurement, a thin layer of grease (about 50 μm) was applied on the cold plate using a notch bar. The LED package with the respective TIM materials was placed on the grease to measure the thermal resistance.

The thermal resistance measurements were carried out by applying a 200 mA heating current to light-up the LED for 60 seconds. The change in voltage (ΔmV) was then measured at a sensing current of 1 mA for 200 seconds. From the change in K factor (K=Δ° C./AmV), the thermal resistance at the interface (° C./W) was calculated.

### Example 2

### 3-Glycidoxypropyltrimethoxysilane (GPTMS)

The effect of surface modification of BN by 3-glycidoxypropyltrimethoxysilane was studied using the following weight ratios given in Table 1. It is observed that the ratio of 1:0.5 BN to 3-glycidoxypropyltrimethoxysilane resulted in a BN layer with poor adhesion to both graphite and aluminium. With an increase in the amount of 3-glycidoxypropyltrimethoxysilane relative to BN, to an amount greater than 1, very good adhesion of the composite material with both graphite and aluminium can be observed.

TABLE 1
h-BN to silane ratio (by weight) for surface modification
with 3-glycidoxypropyltrimethoxysilane

| | BN | | | 1-Methoxy | |
|---|---|---|---|---|---|
| Sample | content | GPTMS | Ratio of | 2-propanol | |
| name | (g) | (g) | BN:GPTMS | (g) | Observation |
| ES1 | 1 | 0.5 | 1:0.5 | 5 | Poor adhesion with graphite and |
| | | | | | aluminum after heat treatment at |
| | | | | | 100° C. for 15 minutes |
| ES2 | 1 | 1 | 1:1 | 5 | Good adhesion with graphite and |
| | | | | | aluminum after heat treatment at |
| | | | | | 100° C. for 15 minutes |
| ES3 | 1 | 1.5 | 1:1.5 | 5 | Good adhesion with graphite and |
| | | | | | aluminum after heat treatment at |
| | | | | | 100° C. for 15 minutes |
| ES4 | 1 | 2 | 1:2 | 5 | Good adhesion with graphite and |
| | | | | | aluminum after heat treatment at |
| | | | | | 100° C. for 15 minutes |
| ES5 | 1 | 2.5 | 1:2.5 | 5 | Good adhesion with graphite and |
| | | | | | aluminum after heat treatment at |
| | | | | | 100° C. for 15 minutes |

### Example 3

### 3-Mercaptopropyltriethoxysilane (MPTMS)

The effect of surface modification of BN with 3-mercaptopropyltriethoxysilane was studied using the following weight ratios given in Table 2. It is observed that at all ratios of BN to 3-mercaptopropyltriethoxysilane, the composite material had poor adhesion to both graphite and aluminium. This indicated that 3-mercaptopropyltriethoxysilane on its own cannot adhere well with graphite and/or aluminium.

TABLE 2
h-BN to silane ratio (by weight) for surface modification
with 3-mercaptopropyltriethoxysilane

| | BN | | | 1-Methoxy | |
|---|---|---|---|---|---|
| Sample | content | MPTMS | Ratio of | 2-propanol | |
| name | (g) | (g) | BN:MPTMS | (g) | Observation |
| MS1 | 1 | 0.5 | 1:0.5 | 5 | Poor adhesion with graphite and |
| | | | | | aluminum. |
| MS2 | 1 | 1 | 1:1 | 5 | Poor adhesion with graphite and |
| | | | | | aluminum. |
| MS3 | 1 | 1.5 | 1:1.5 | 5 | Poor adhesion with graphite and |
| | | | | | aluminum. |
| MS4 | 1 | 2 | 1:2 | 5 | Poor adhesion with graphite and |
| | | | | | aluminum. |
| MS5 | 1 | 2.5 | 1:2.5 | 5 | Poor adhesion with graphite and |
| | | | | | aluminum. |

### Example 4

### Mixture of 3-Glycidoxypropyltrimethoxysilane (GPTMS) and 3-Mercaptopropyltriethoxysilane (MPTMS)

The effect of surface modification of BN using a mixture of 3-glycidoxypropyltrimethoxysilane and 3-mercaptopropyltriethoxysilane mixture was studied using the following weight ratios given in Table 3. It is observed that at a ratio of 1:0.5 of BN to a mixture of 3-glycidoxypropyltrimethoxysilane and 3-mercaptopropyltriethoxysilane, the composite material has poor adhesion to both graphite and aluminium. With an increase in the amount of the mixture of 3-glycidoxypropyltrimethoxysilane and 3-mercaptopropyltriethoxysilane relative to BN, to an amount greater than 1, the composite material was observed to have good adhesion to both graphite and aluminium.

TABLE 3
h-BN to silane ratio (by weight) for surface modification with a mixture
of 3-glycidoxypropyl trimethoxysilane and 3-mercaptopropyltriethoxysilane

| | BN | | | Ratio of | 1-Methoxy | |
|---|---|---|---|---|---|---|
| Sample | content | GPTMS | MPTMS | h-BN:GPTMS- | 2-propanol | |
| name | (g) | (g) | (g) | MPTMS mixture | (g) | Observation |
| ES-MS1 | 1 | 0.025 | 0.025 | 1:0.5 | 5 | Poor adhesion with graphite |
| | | | | | | and aluminum after heat |
| | | | | | | treatment at 100° C. for 15 |
| | | | | | | minutes |
| ES-MS2 | 1 | 0.5 | 0.5 | 1:1 | 5 | Good adhesion with graphite |
| | | | | | | and aluminum after heat |
| | | | | | | treatment at 100° C. for 15 |
| | | | | | | minutes |
| ES-MS3 | 1 | 0.75 | 0.75 | 1:1.5 | 5 | Good adhesion with graphite |
| | | | | | | and aluminum after heat |
| | | | | | | treatment at 100° C. for 15 |
| | | | | | | minutes |
| ES-MS4 | 1 | 1 | 1 | 1:2 | 5 | Good adhesion with graphite |
| | | | | | | and aluminum after heat |
| | | | | | | treatment at 100° C. for 15 |
| | | | | | | minutes |
| ES-MS5 | 1 | 1.25 | 1.25 | 1:2.5 | 5 | Good adhesion with graphite |
| | | | | | | and aluminum after heat |
| | | | | | | treatment at 100° C. for 15 |
| | | | | | | minutes |

### Example 5

### FTIR Results

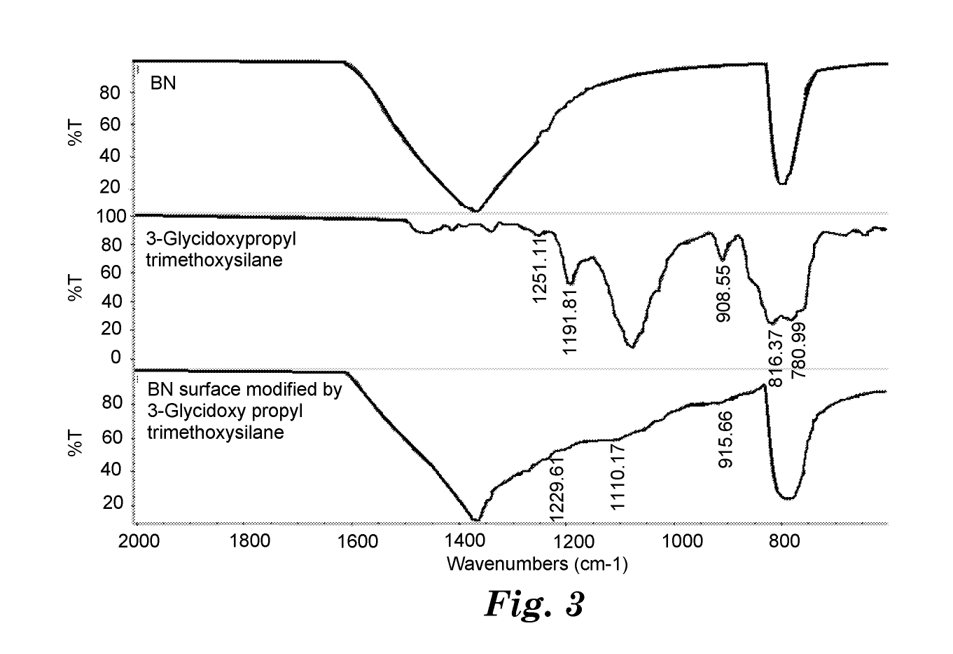

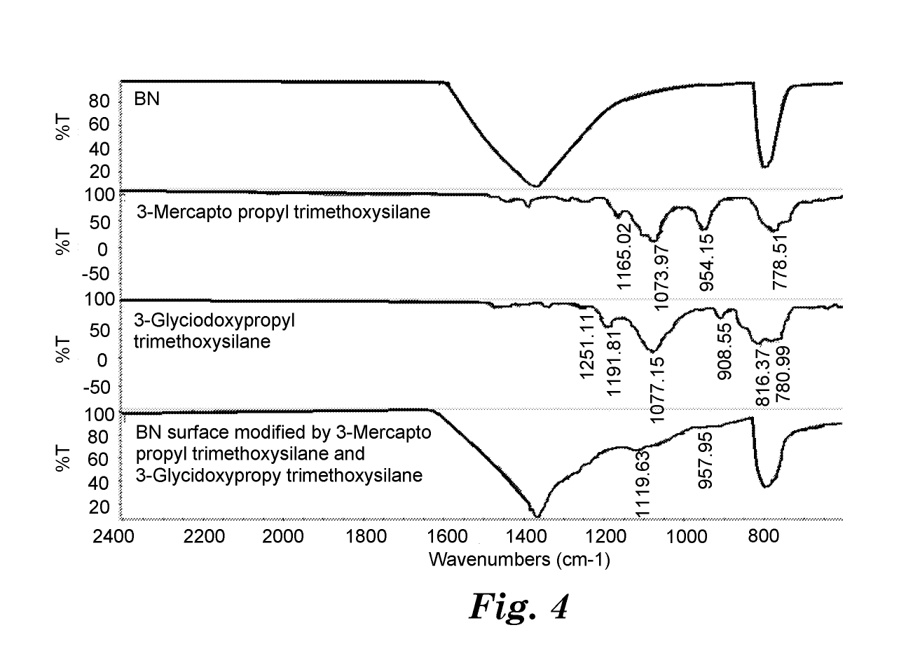

The FT-IR spectrum of the as obtained h-BN, 3-glycidoxypropyltrimethoxysilane (GPTMS) and the surface modified h-BN (ES3 of Table 1) having 1:1.5 ratio of h-BN:GPTMS was measured and compared (FIG. 3). In addition, the FT-IR spectrum of the as obtained h-BN, 3-glycidoxypropyltrimethoxysilane (GPTMS), 3-mercaptopropyl triethoxysilane (MPTMS) and the h-BN surface modified with a mixture of GPTMS and 3-mercaptopropyl triethoxysilane (h-BN: GPTMS-MPTMS mixture ratio of 1:1.5) was measured and compared (FIG. 4).

The FT-IR spectrum of the h-BN (FIG. 3 and FIG. 4) shows two distinct characteristic absorption bands at 1375 and 795 cm⁻¹ representing BN stretching and BN bending, respectively.

Two characteristic absorptions of the oxirane ring are observed at 910 cm⁻¹, due to the C—O group and at 3050 cm⁻¹ due to the C—H tension of the methylene group of the epoxy ring. The band at 1250 cm⁻¹ belongs to CO bonds of the GPTMS. After surface modification, two changes are observed with the FTIR frequencies corresponding to the GPTMS. The peak intensity at 910 cm⁻¹ corresponding to the epoxy ring decreases, indicating a possible ring opening. The band at 1250 cm⁻¹ which belongs to C—O bonds of GPTMS, also disappears indicating a ring opening. The twin absorption peaks corresponding to GPTMS in the range of 2850-3100 cm⁻¹ is attributed to C—H stretching mode vibrations of the methyl group. After heat treatment, these peaks broaden with the appearance of another peak at 2950 cm⁻¹.

The C—C stretching and CH bending modes at 1300-1500 cm⁻¹ and the CH stretching mode at 2900-3000 cm⁻¹ also appears in the surface modified h-BN. The new absorption peak at 1163cm⁻¹ is attributed to N—H wagging. The broadened peak 3200-3600 cm⁻¹ is due to B—OH and B—N—H vibrations. It is to be noted that in the as received h-BN, such peak broadening is absent confirming the formation of B—OH and B—N—H bonds after surface modification. The peak at 948 cm⁻¹ is due to the Si—O absorption which is observed in the surface modified h-BN. The peak broadening at 1000-1150 cm⁻¹ is attributed to the Si—O—Si stretching, indicating siloxane crosslinking. The peak corresponding to B—O—Si bond formation usually appears at about 915 -930 cm⁻¹. However, this small peak was not obvious due to possible masking by the Si—O—Si—O linkages due to higher silane to h-BN ratio. In the present study, the silane content used was intentionally higher than that was actually needed to surface modify h-BN, to improve the adhesion of h-BN with aluminium and graphite substrates.

### Example 6

### Thermal Conductivity

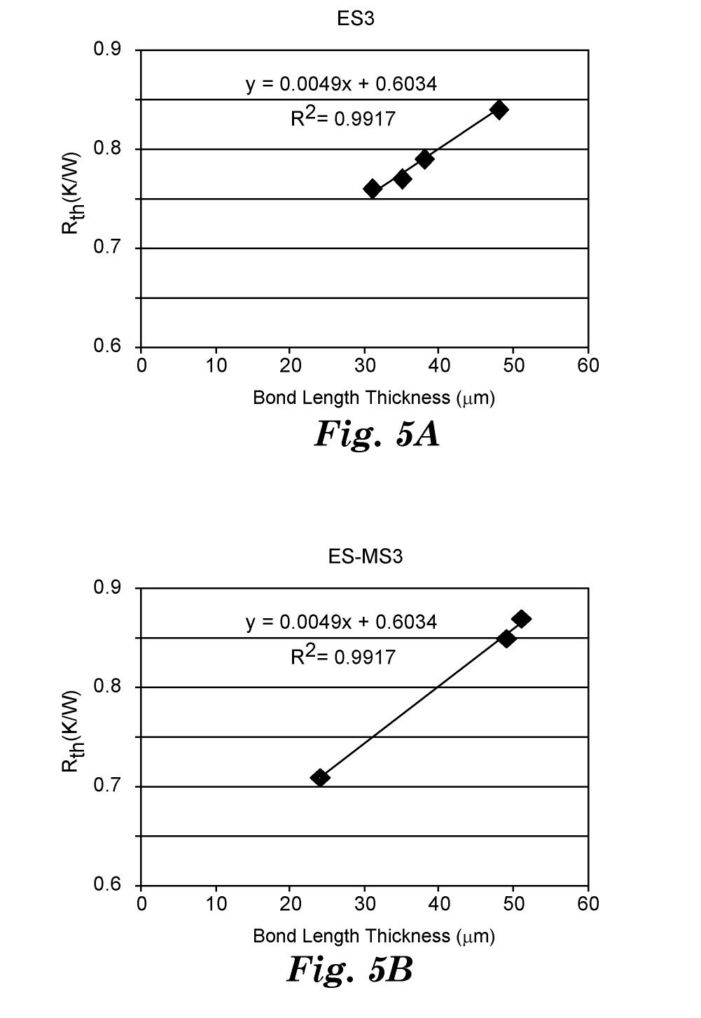

The thermal conductivity of surface modified h-BN with GPTMPS and a mixture of GPTMS with MPTMS at a h-BN to silane ratio of 1:1.5 (ES3 and ES-MS3, respectively) coated on graphite film to different thicknesses and measured using Dyn-TIM are shown in FIG. 5 and Table 4. The thermal conductivity (k) was calculated from the slope of the graph plotting thermal resistance as a function of bond length thickness. Thermal conductivity of ES3 was 1.59 W/mK, while that of ES-MS3 was slightly lower at 1.38 W/mK. Both of the surface modified h-BN demonstrated better performance than typical thermally conductive adhesive transfer tapes (3M Tape 8805) which have a thermal conductivity(k) in the range of 0.5-0.9 W/mK.

TABLE 4
Thermal conductivity of h-BN surface modified with
GPTMS (ES3) and mixture of GPTMS and MPTMS (ES-MS3)

| Sample | k (W/mK) | σk (W/mK) | R² |
|---|---|---|---|
| ES3 | 1.59 | 0.07 | 0.9917 |
| ES-MS3 | 1.38 | 0.03 | 0.9977 |

### Example 7

### Thermal Resistance

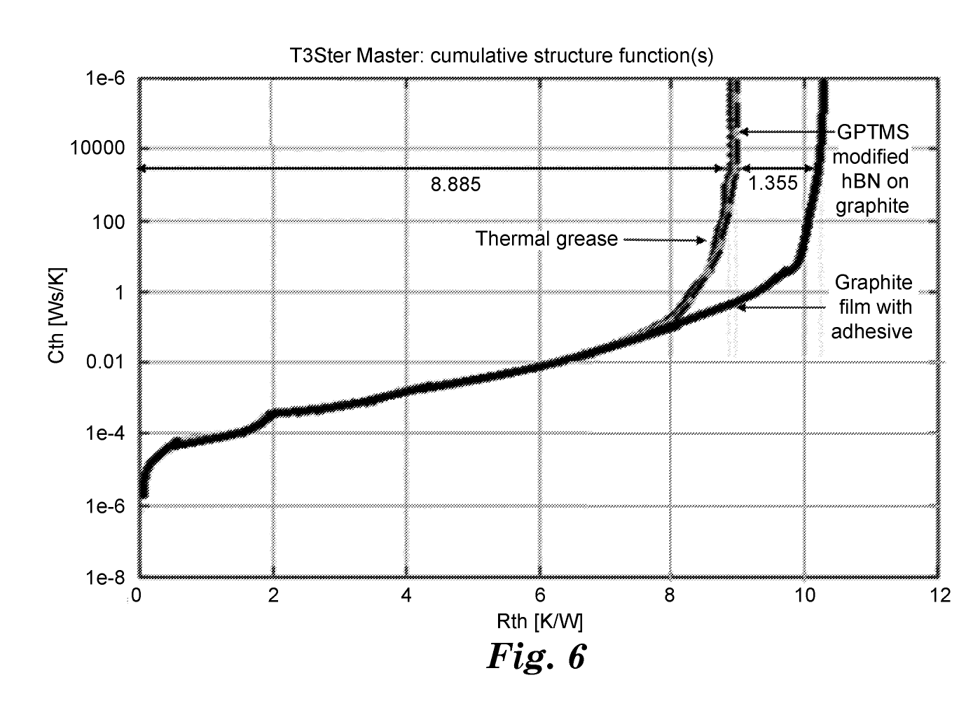

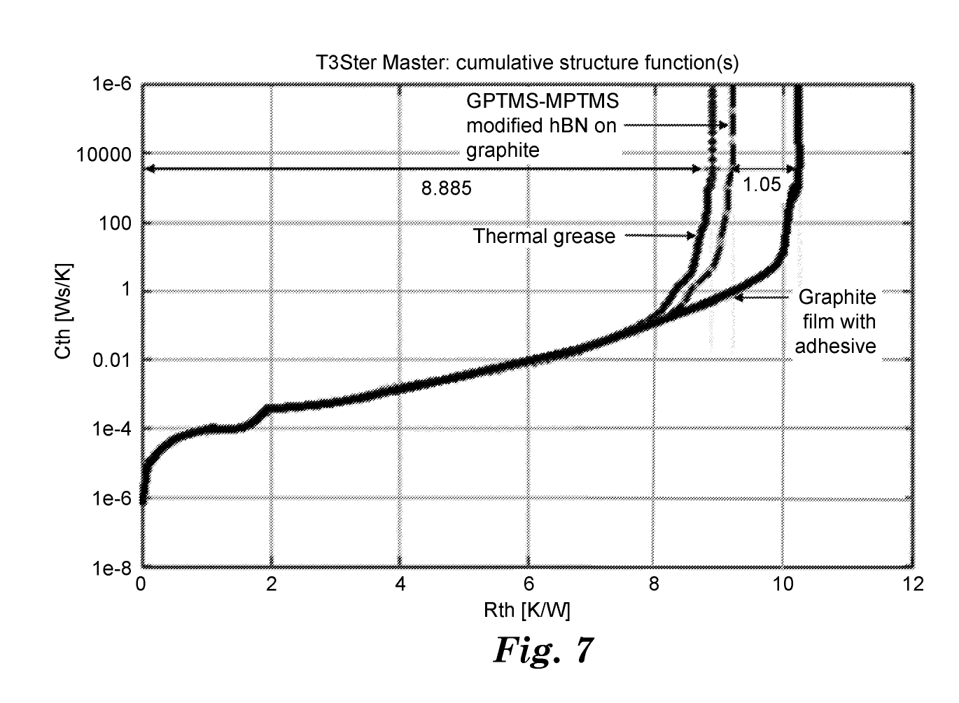

The interfacial thermal resistance of h-BN that has been surface modified with GPTMS and a mixture of GPTMS with 3-MPTMS at a h-BN to silane ratio of 1:1.5 coated on graphite sheets was studied in comparison with (i) thermal grease and (ii) graphite film coated with adhesive. The results are shown in FIG. 6 and FIG. 7.

h-BN Coated on Single Side of Graphite Film

The thermal capacitance (ordinate) vs thermal resistance (abscissa) values of the LED package using (i) thermal grease, (ii) h-BN surface modified with GPTMS coated on graphite film and (iii) commercially available graphite sheet coated with adhesive are shown in FIG. 6 and Table 5. The thermal resistance of all the three thermal interface materials (TIM) with the LED package follow the same trend up to 8° K/W, which is due to the thermal resistance of the LED package. Beyond 8° K/W, the individual thermal resistance of the TIM became obvious. With the use of thermal grease as the TIM, the total thermal resistance of the LED package increased to 8.88° K/W from 8.00° K/W. Similarly, with graphite film with adhesive as TIM tested over a thin layer of thermal grease exhibited a thermal resistance of 10.24° K/W. The surface modified h-BN layer over graphite as TIM tested over a thin layer of grease showed a reduced thermal resistance of 8.97° K/W. The thermal resistance values clearly indicated that the replacement of adhesive with surface modified h-BN layer had a positive effect by reducing thermal resistance.

A similar observation was made with h-BN that was surface modified using a mixture of GPTMS and MPTMS (FIG. 7). While the thermal grease increased the total thermal resistance of LED package to 8.88° K/W from 8.00° K/W, the graphite film with adhesive further increased the thermal resistance to 10.24° K/W. With the use of surface modified h-BN on graphite film tested over grease, total thermal resistance was observed to be 9.19° K/W. The replacement of adhesive with h-BN layer was shown to bring down the thermal resistance. This further confirms that the surface modified h-BN can bring down the thermal resistance of the graphite film based TIM by about 1-1.35° K/W, which certainly would improve the heat transfer and dissipation during the operation of the LED package.

TABLE 5
Thermal resistance measurement with different TIM compositions

| | Total Thermal Resistance (° K/W) | | | Decrease in total |
|---|---|---|---|---|
| | | | Graphite film | thermal resistance |
| | | Graphite film | with surface | compared to surface |
| | Thermal | with | modified | modified h-BN coating |
| Surface Treatment | grease | adhesive | h-BN | (° K/W) |
| h-BN surface | 8.85 | 10.24 | 8.97 | 1.35 |
| modified with | | | | |
| GPTMS | | | | |
| h-BN surface | 8.85 | 10.24 | 9.19 | 1.05 |
| modified with | | | | |
| mixture of GPTMS | | | | |
| and MPTMS | | | | |

h-BN Coated on Both Sides of Graphite Film

The thermal performance of the graphite film coated on both sides with surface modified h-BN was studied through T3 STER and compared with that of graphite sheet coated on one side with surface modified h-BN and thermal tape (3M Tape 8805) that is commercially available and typically used for LED applications. The samples were used as thermal interface material between an LED package and a finned heat sink to simulate a typical LED application. For graphite sheets coated on one side with surface modified h-BN, the surface modified h-BN was bonded to the bottom surface of the LED package and thermal grease was used to facilitate the heat transfer between the graphite sheet and heat sink. For the graphite sheet coated on both sides with surface modified h-BN, one side of the graphite film coated with the surface modified h-BN was bonded onto the bottom surface of LED package and the other side was bonded onto the heat sink.

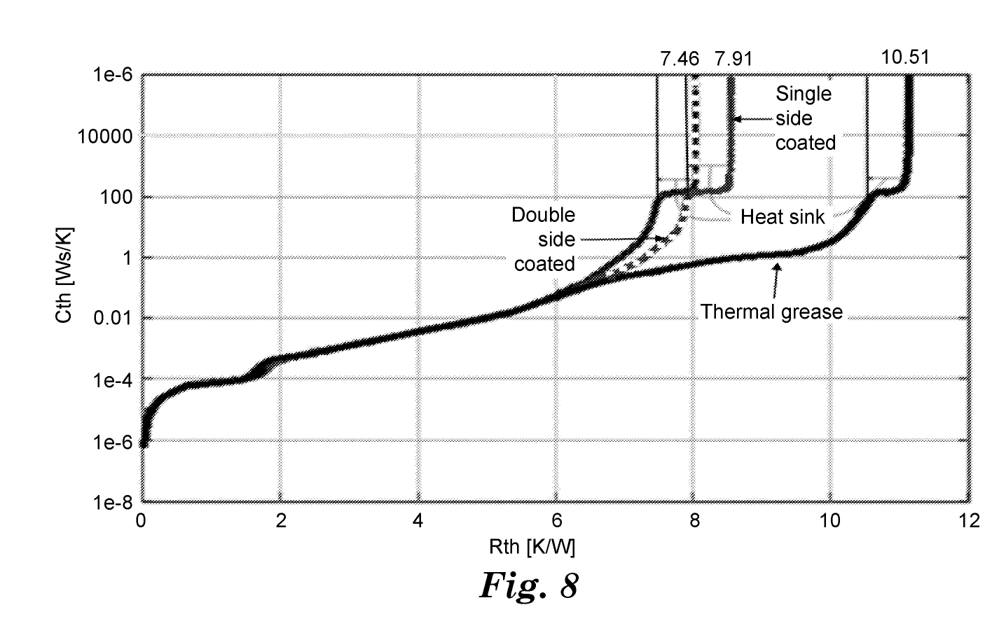

For the present thermal testing, an LED package with 6° K/W thermal resistance was used. The LED package used in this measurement is different to the one used above for the measurement of heat resistance of h-BN coated on single side of graphite film (8° K/W), which may lead to a slight variation in the total thermal resistance due to the variation of the LED package. In addition, the thermal resistance from the heat sink was clearly observed in these measurements, as shown in FIG. 8. The preliminary thermal resistance measurements of the three TIM are shown in FIG. 8 and Table 6. The total thermal resistance reported in Table 6 is without the thermal resistance of heat sink.

TABLE 6
Total thermal resistance of LED package surface modified h-BN coated
on one or two sides of the graphite sheet the TIM material

| | Thickness | Total Rₜₕ |
|---|---|---|
| TIM | (μm) | (K/W)* |
| LED Package | — | 6 |
| Graphite sheet coated with surface modified h-BN | ~35 | 7.91 |
| coated on one side | | |
| Graphite sheet coated with surface modified h-BN | ~45 | 7.46 |
| coated on two sides | | |
| Thermal Tape (3M Tape 8805) | 50 | 10.51 |

*Total Rₜₕ without heat sink

From the above results, it can be observed that despite the increase in thickness by 10 μm in the graphite film coated with surface modified h-BN on both sides compared to the graphite film coated on one side only, the total thermal resistance was still lower, with the graphite film coated with surface modified h-BN on both sides showing a lower thermal resistance of 7.46° K/W compared to the 7.91° K/W for graphite film coated on one side only or 10.5° K/W of the thermal resistance of the thermal tape. This result indicates that the surface modified h-BN is effective in not only replacing thermal grease but also in terms of bonding and dielectric properties. The graphite film coated with surface modified h-BN on both sides also outperformed the thermal tape by 2.9 K/W, which is a significant improvement from existing products.

Altering the nitride to silane ratio in the range of 1:0.5 to 1:2.5, did not alter the total thermal resistance of the LED package. This indicates that there is negligible influence of silane content in altering the thermal resistance.

### Example 8

### Microstructure

The surface modified h-BN particles coated on graphite sheet was studied using scanning electron microscopy (SEM) to find out the alignment of the particles in the coating microstructure. The microstructure shows most of the particles to be in the size range of about 0.5-1 μm with horizontal alignment. The surface modification by GPTMS and the mixture of GPTMS and MPTMS both resulted in horizontal alignment of particles forming a closely connected network of thermally conductive pathways. The microstructure also shows the individual particles clearly due to the very little organic content in the coating in contrast to conventional resin based coatings where the particles were mostly embedded in the resin resulting in particle separation without close network formation.

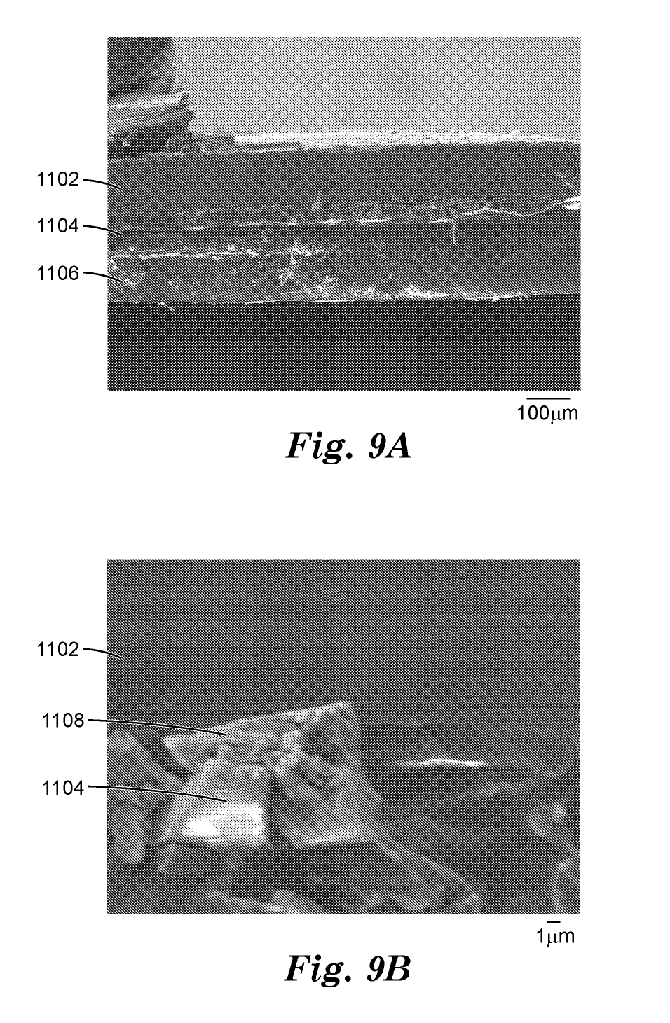

The cross-sectional microstructure of the graphite film coated with surface modified h-BN bonded with aluminium sheet (representing the substrate below the LED package to connect the heat source to the TIM material) is shown in FIG. 9.

FIG. 9A shows the aluminium base of the LED package (1106), a layer of surface modified h-BN in the middle (1104) and the graphite film on top (1102). The image shows the h-BN layer aligned more or less uniformly between the graphite and aluminium layers. At higher magnification (FIG. 9B), the layered structure of the graphite film (1102) was observed and a uniform layer of surface modified h-BN (1104) can be observed below that. The interface (1108) between the h-BN layer and the graphite layer is in full contact. This uniform contact between the thermally conductive h-BN particles with the graphite layer results in very good thermal conductivity. In conventional graphite sheets with an adhesive layer, such a thermally conductive path is absent, therefore resulting in higher interfacial thermal resistance.

### INDUSTRIAL APPLICABILITY

The composite material of as defined above may be used as a thermal interface material to be placed between a heat source and a heat sink to dissipate the heat generated by the heat source. The composite material as defined above may be used to bond to the heat source and/or the heat sink without the use of additional adhesives.

The composite material may be used as a heat spreader with higher in plane thermal conductivity (along x-y axis) apart from its use as a thermal interface material to improve the through plane thermal conductivity (along z-axis). Since the x-y thermal conductivity of the nitride such as h-BN is much higher (600 W/mK) than the z-axis conductivity (30 W/mK), the use of the composite material on graphite sheet may increase the x-y thermal conductivity to a greater extent when compared to the graphite sheet with adhesives or adhesive filled with thermal conducting particles like alumina, BN and AlN. The use of surface modified BN to bond graphite sheet with the heat source/heat sink would not only improve the z-axis thermal conductivity (as TIM material) but also would improve the x-y plane thermal conductivity compared to graphite sheet with adhesive.

Apart from its use with graphite sheet, the composite material on its own, may act as a heat spreader material to spread heat from heat source along the x-y plane.

The method for synthesizing the composite material as defined above may be used to prepare the composite material in a fast, efficient and cost-effective manner.

It will be apparent that various other modifications and adaptations of the invention will be apparent to the person skilled in the art after reading the foregoing disclosure without departing from the spirit and scope of the invention and it is intended that all such modifications and adaptations come within the scope of the appended embodiments.

1. A composite material comprising a thermally conductive component in the form of a sheet that is coated with a surface modified nitride, wherein the nitride is surface modified with at least one silane compound having the following formula (I):
R¹—(X¹)ₘ—(CR³R⁴)ₘ—Si(—O—R²)₃ (I)
wherein R¹ is selected from the group consisting of halogen, thiol, optionally substituted alkyl, optionally substituted alkenyl, optionally substituted alkynyl, optionally substituted amino, optionally substituted hydroxylalkyl, optionally substituted acylamino, optionally substituted acyloxy, optionally substituted cycloalkyl, optionally substituted cycloalkenyl, optionally substituted heterocycloalkyl, optionally substituted heterocycloalkenyl and —(C(X²)₂)_{y};
each occurrence of R² is independently selected from the group consisting of hydrogen, optionally substituted alkyl and silane ester;
each occurrence of R³ and R⁴ are independently hydrogen or optionally substituted alkyl;
each occurrence of X¹ or X² are linkers independently selected from the group consisting of a bond, optionally substituted alkyl, optionally substituted alkenyl, optionally substituted alkynyl, optionally substituted heteroalkyl, optionally substituted heteroalkenly, optionally substituted heteroalkynyl, optionally substituted alkyloxy, optionally substituted alkenyloxy, optionally substituted alkynyloxy, optionally substituted acyloxy, optionally substituted amino and optionally substituted acylamino;
m and n are independently any integer from 0 to 6; and
y is any integer from 1 to 200.

2. The composite material of claim 1, wherein the nitride is a nitride of a group 13 element.

3. The composite material of claim 2, wherein the nitride is a nitride of a group 13 element and the group 13 element is selected from the group consisting of boron, aluminium, gallium, indium and thallium.

4. The composite material of claim 1, wherein each occurrence of X¹ is a bond, optionally substituted heteroalkyl, optionally substituted alkyloxy or optionally substituted alkylamino.

5. The composite material of claim 1, wherein the silane compound has the following formula (Ia):
R¹—(CH₂—O)ₙ—(CR³R⁴)ₘ—Si(—O—R²)₃ (Ia)
wherein n is 0 or 1,
m is any integer from 0 to 6;
R¹ is selected from the group consisting of halogen, thiol, optionally substituted alkyl, optionally substituted amino, optionally substituted cycloalkyl, optionally substituted heterocycloalkyl, optionally substituted acyloxy and —(C(X²)₂)_{y};
each occurrence of R³ and R⁴ are independently hydrogen or methyl; and
each occurrence of R² is independently hydrogen, an optionally substituted C₁ to C₅ alkyl or a silane ester.

6. The composite material of claim 1, wherein the silane compound has the following formula (Ib) to (Ie):
R¹—(CH₂—O)ₙ—(CH₂)ₘ—Si(—O—R²)₃, (Ib)
R¹—(CH₂—O)ₙ—(CH(CH₃))ₘ—Si(—O—R²)₃, (Ic)
R¹—(CH₂—O)ₙ—(CH₂)ₘ—Si(—O—Si—(CH₂)ₘ—(CH₂—O)ₘ—R¹)₃; (Id)
R¹—(CH₂—O)ₙ—(CH(CH₃))ₘ—Si(—O—Si—(CH(CH₃))ₘ—(CH₂—O)ₙ—R¹)₃; (Ie)
and any mixture thereof,
wherein R² is selected from hydrogen, methyl or ethyl.

7. The composite material of claim 1, wherein the silane compound of formula (I) is selected from the group consisting of 3-glycidoxypropyltrimethoxysilane, 3-glycidoxypropyltriethoxysilane, 5,6-epoxyhexyltriethoxysilane, 3-glycidoxypropylmethyldiethoxysilane, 3-glycidoxypropylmethyldimethoxysilane, 3-glycidoxypropyldimethylethoxysilane, 2-(3,4-epoxycyclohexyl)ethyltriethoxysilane, 2-(3,4-epoxycyclohexyl)ethyltrimethoxysilane, 3-aminopropyltrimethoxysilane, [3-(diethylamino)propyl]trimethoxysilane, N-3-[amino(polypropylenoxy)]aminopropyltrimethoxysilane, (diethylamino)trimethylsilane, triethoxysilyl modified poly-1,2-butadiene, trimethoxysilyl modified poly-1,2-butadiene, diethoxymethylsilyl modified poly-1,2-butadiene, triethoxysilylethyl(ethylene-1,4 butadienestyrene) terpolymer, 3-methacryloxypropyltrimethoxysilane, 3-mercaptopropyltrimethoxysilane (MPTMS) and 3-mercaptopropyltriethoxysilane.

8. The composite material of claim 1, wherein the silane compound of formula (I) is selected from the group consisting of 3-glycidoxypropyltrimethoxy silane (GPTMS), 3-mercaptopropyltrimethoxysilane (MPTMS) and any mixture thereof.

9. The composite material of claim 1, wherein the weight ratio between the nitride and at least one compound having the formula (I) is in the range of 1:1 to 1:5.

10. The composite material of claim 1, wherein the thermally conductive component is in the form of a sheet.

11. The composite material of claim 1, wherein the thermally conductive component is graphite.

12. The composite material of claim 1, wherein the composite material is substantially free of any adhesives other than the surface modified nitride.

13. The composite material of claim 1, wherein the composite material has a thickness in the range of 10 μm to about 250 μm.

14. An article comprising a composite material of claim 1, bonded onto a heat source, a heat sink or both.
